(19) United States
(12) Patent Application Publication
(10) Pub. No.: US 2019/0108517 A1
(43) Pub. Date: Apr. 11, 2019

(54) DIGITAL CURRENCY FOR PERFORMING CASH-EQUIVALENT TRANSACTIONS

(71) Applicant: ALLOCRYPT, LLC, La Jolla, CA (US)

(72) Inventor: Gregory G. Rose, La Jolla, CA (US)

(21) Appl. No.: 16/153,571

(22) Filed: Oct. 5, 2018

Related U.S. Application Data
(60) Provisional application No. 62/569,477, filed on Oct. 6, 2017.

(51) Int. Cl. G06Q 20/38; G06Q 20/06

(52) U.S. Cl. CPC G06Q 20/3829; G06Q 2220/00; G06Q 20/3827; G06Q 20/065

(57) ABSTRACT

Cash-like anonymous transactions are facilitated using digital cash that cannot be traced to the payor. A payor requests a (payor) bank to issue a digital cash certificate be generated for a particular amount. The bank generates the digital cash certificate and associates a unique note identifier with the digital cash certificate. The digital cash certificate, including the denomination and the unique note identifier, are obscured/blinded using a payor public key for to obtain an encrypted digital cash certificate. The bank may cryptographically sign the encrypted digital cash certificate, using a denomination-specific private key, and returns the signed and encrypted digital cash certificate to the payor. The payor may decrypt the encrypted digital cash certificate to obtain a cryptographically signed digital cash certificate. The payor can a representation of the signed digital cash certificate to a payee. The payee can the signed digital cash certificate to a (payee) bank for redemption.

The present application for patent claims priority to U.S. Provisional Application No. 62/569,477 filed Oct. 6, 2017 which is hereby expressly incorporated by reference.

### BACKGROUND

### Field

Various features relate to the methods and devices for digital currency, and more particularly, to a way for generating and using digital currency for transactions while providing anonymity to the bearer or payor.

### Background

Society is becoming increasingly privacy-conscious, at the same time that personal privacy is being eroded by government and commercial intrusions. Cash transactions are one method for preserving anonymity and privacy. For example, some perfectly legal transactions nevertheless carry some social stigma, such as buying medical marijuana, medication for HIV/AIDS, pornography, or sex aids. Purchasers often use cash for such transactions. At the same time, the businesses that receive the cash have a problem: they are known to have a lot of cash on hand, are at risk of being robbed, and need expensive physical security.

There are a number of existing systems that have been or are digital equivalents for cash. One example of such digital cash is DigiCash (Chaum, David (1983). “Blind signatures for untraceable payments”, Advances in Cryptology Proceedings of Crypto, 199-203 (1982), based on a cryptographic concept called blind signatures. Stefan Brands later introduced a conceptually similar scheme based on a different mathematical problem. In both cases a specially crafted message represents a certain value amount. The customer creates a randomized but appropriately formatted message, encrypts it, and sends it to the bank. The bank debits the customer's account, signs the message, and returns it to the customer. This is where the blind signature comes in, the special algorithm allows the customer to decrypt the message, but the bank's signature is still valid on the decrypted message. The customer may then send this message to a vendor. The vendor may send the message to the bank, which verifies that the signature is valid (e.g., that it is worth a certain monetary value), and also checks that the particular message has not been deposited before by keeping track of deposits/accounts. Upon successful confirmation of the message, the bank credits the vendor's account and informs the vendor that the payment has been deposited. If the customer tries to send the same message to another vendor, the bank will notice and tell the second vendor that the message is no longer valid. However, the bank cannot link the customer to the vendor since the bank never saw the original message, only an encryption of it. The customer and the bank, together, can prove that the money was given to the vendor, in case of fraud.

More recently, digital cash schemes like Bitcoin (introduced under the pseudonymous Satoshi Nakamoto. Nakamoto, Satoshi (October 2008), “Bitcoin: A Peer-to-Peer Electronic Cash System”, bitcoin.org, retrieved 28 Apr. 2014), Etherium and Zerocash have become popular. While bitcoin is used herein as example, any of these digital currencies could be used. These are based on a mechanism called blockchains, where the specially formatted messages directly represent value. Security against multiple spending comes from a publicly available ledger that traces conversion of value (such as splitting a bitcoin into multiple smaller-value bitcoins).

However, existing digital cash schemes cannot be conveniently used for cash-like transactions while maintaining a payor's anonymity. Therefore, a way is needed to securely and conveniently use digital cash for cash-like transactions while maintaining payor and/or payee anonymity.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 (comprising FIGS. 1A, 1B, 1C, 1D, and 1E) illustrates a first example of a system for using digital cash for cash-like transactions while maintaining anonymity.

FIG. 2 illustrates a method operational in a customer device to generate and tender digital cash without associating it to the customer.

FIG. 3 illustrates a method operational in a vendor device to accept and redeem digital cash.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

A first aspect provides a system that facilitates cash-like transactions using digital cash that cannot be traced to the payor, thereby providing payor anonymity in transactions. A payor requests a (payor) bank or financial institution to generate or issue a digital cash certificate or note be generated for a particular amount. A (payor) bank or financial institution generates the digital cash certificate or note and associates a unique note identifier with the digital cash certificate. The digital cash certificate, including the denomination and the unique note identifier, are obscured/blinded using a payor public key for to obtain an encrypted digital cash certificate. The bank or financial institution may cryptographically sign the encrypted digital cash certificate, using a denomination-specific private key, and returns the signed and encrypted digital cash certificate to the payor. Upon receipt, the payor may decrypt (unblinds) the encrypted digital cash certificate to obtain a cryptographically signed digital cash certificate. At this point, the payor may tender a representation of the signed digital cash certificate to a payee. The payee may present the signed digital cash certificate to a (payee) bank or financial institution for redemption. Because the signed digital cash certificate cannot be traced back to the payor, this provides cash-like anonymity or privacy to the payor for the transaction.

A second aspect provides an authentication service (or authentication server/provider) that receives and maintains a database of unique note identifiers and corresponding amounts. When a digital cash certificate/note is presented at the (payee) bank or financial institution for redemption, the (payee) bank or financial institution verifies with the authentication service that it has not been previously redeemed and it is valid. A unique note identifier, for the digital cash certificate/note, may be obtained by to the authentication service (by using a denomination-specific public key for the issuing bank to obtain the digital cash unique note identifier) which maintains a database of previously redeemed notes (e.g., identified by the note identifier, etc.). In one example, the database is populated as the digital cash certificates/notes are first presented to the authentication service. The fact that a digital cash certificate/note is not found in the database indicates that it has not been spent previously. When presented for the first time to the authentication service (e.g., upon being spent or redeemed), the digital cash certificate/note is added to the database. If the digital cash certificate is valid and not previously redeemed, the authentication service informs the (payee) bank or financial institution that it can be redeemed. Otherwise, if the unique note identifier (for the digital cash certificate/note) is found in the database, then the authentication service may reject the transaction (e.g., e.g., indicate that the digital cash certificate/note was previously redeemed or is invalid). Because neither the digital cash certificate nor the unique note identifier can be traced to the payor, the payor's anonymity is maintained.

A third aspect provides a user device and/or application operational thereon that is configured to obtain digital cash from a (payor) bank or financial institution and tender the digital cash to a payee or vendor as payment for a transaction without linking the payor to the payee.

A fourth aspect provides a way to generate digital cash certificates/notes having both standard and non-standard denomination values. In some instances, a payor may request/obtain digital cash certificate(s)/note(s) in an amount corresponding to standard denomination values for a particular currency selected or desired. In other instances, a payor may request/obtain digital cash certificate(s)/note(s) in an exact amount of an intended transaction (e.g., non-standard denomination values, including fractional amount such as cents).

### Exemplary Infrastructure

A centralized service may enable the confidential/secure generation and distribution of digital cash certificates that can be used without disclosing the identity of the bearer or payor. The digital cash certificate can be used and tendered as cash currency by a payor and redeemed by a payee. The centralized service may validate a redemption of a digital cash certificate (e.g., correct amount or currency) and also that it has not been previously redeemed.

A bank or financial institution may be configured to receive requests from payors/customers to obtain digital cash from the payor's/customer's account. The (payor) bank or financial institution may be configured to generate digital cash certificates/notes in the amount request if the requesting payor/customer has such amount in the payor's/customer's account. The bank or financial institution may then send the digital cash certificate to the requesting payor.

A customer device may be any electronic device capable of communicating with the bank or financial institution to request digital cash, receive a digital cash certificate, and/or to tender the digital cash certificate to a payee or vendor.

### Exemplary Printer Devices

Another aspect provides printer devices that may be capable of generating representations of a digital cash certificate. The printer boxes/devices described herein may include an integrated power source (e.g., battery, power cell, etc.) or may be externally powered. Additionally, the printer boxes/devices may include one or more circuits and/or processing circuits configured to print/output digital cash certificates/notes received by the printer boxes/devices. The boxes/devices may include a communication interface/circuit (wired/wireless) to communicate with other devices. In various examples, the communication interface/circuit may be a Bluetooth-compatible interface or internet-capable communication interface. The printer devices may be connected, e.g., via either WiFi or a wired connection, to the Internet (or a communication network). The boxes/devices may be able to directly interface to a bank or financial institution that generates digital cash certificates/notes.

First Exemplary Approach for Use Digital Cash for Cash-Like Transactions while Maintaining Anonymity

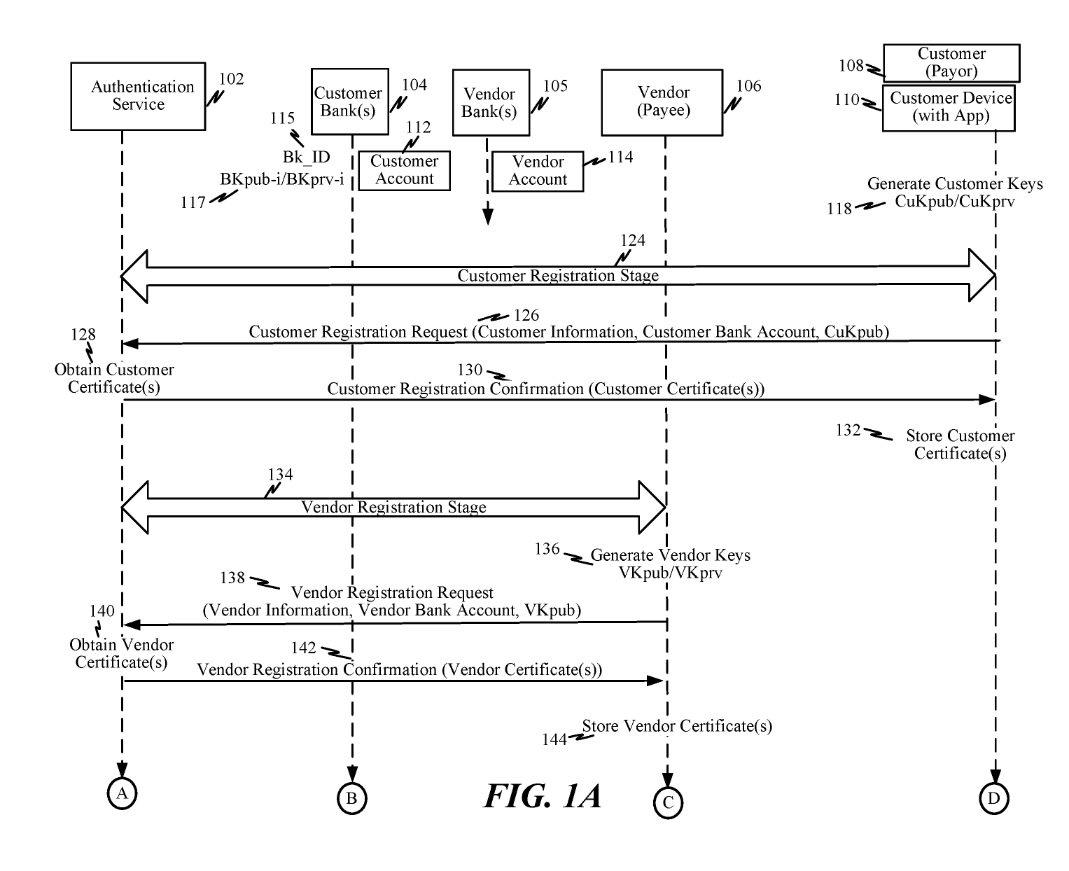

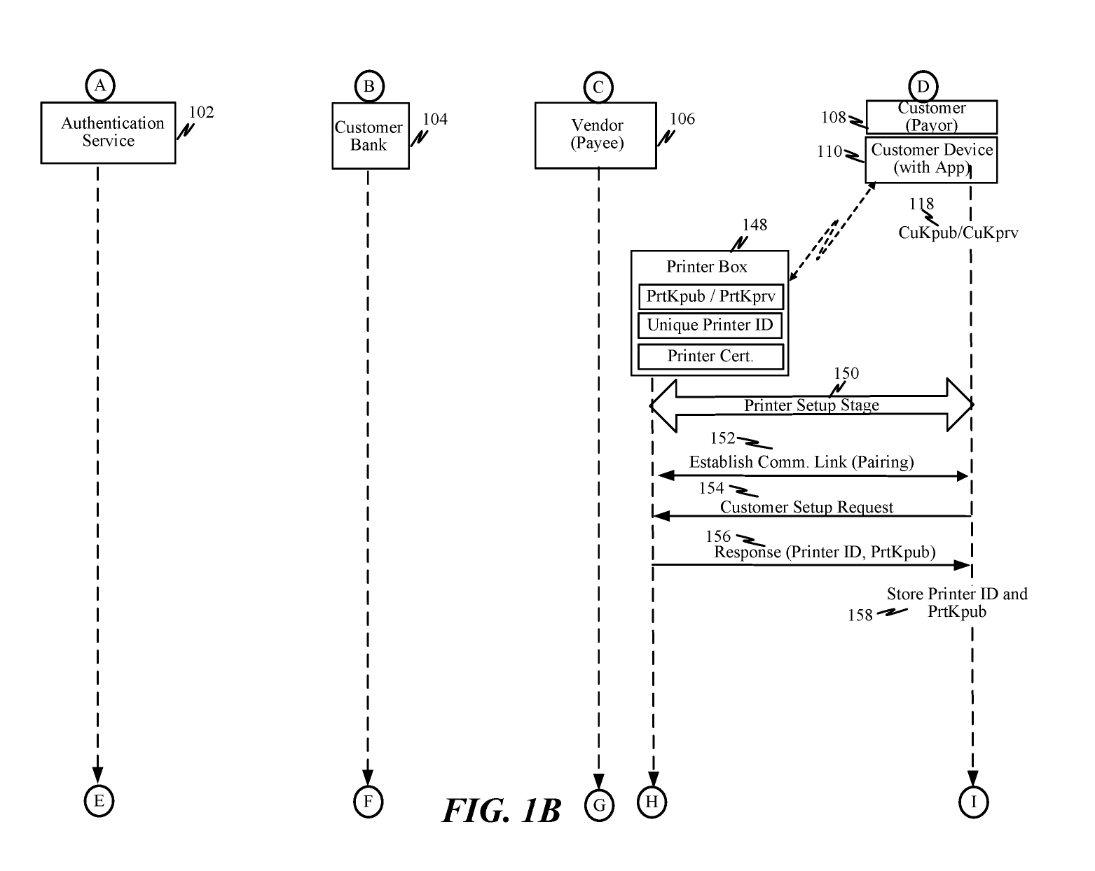

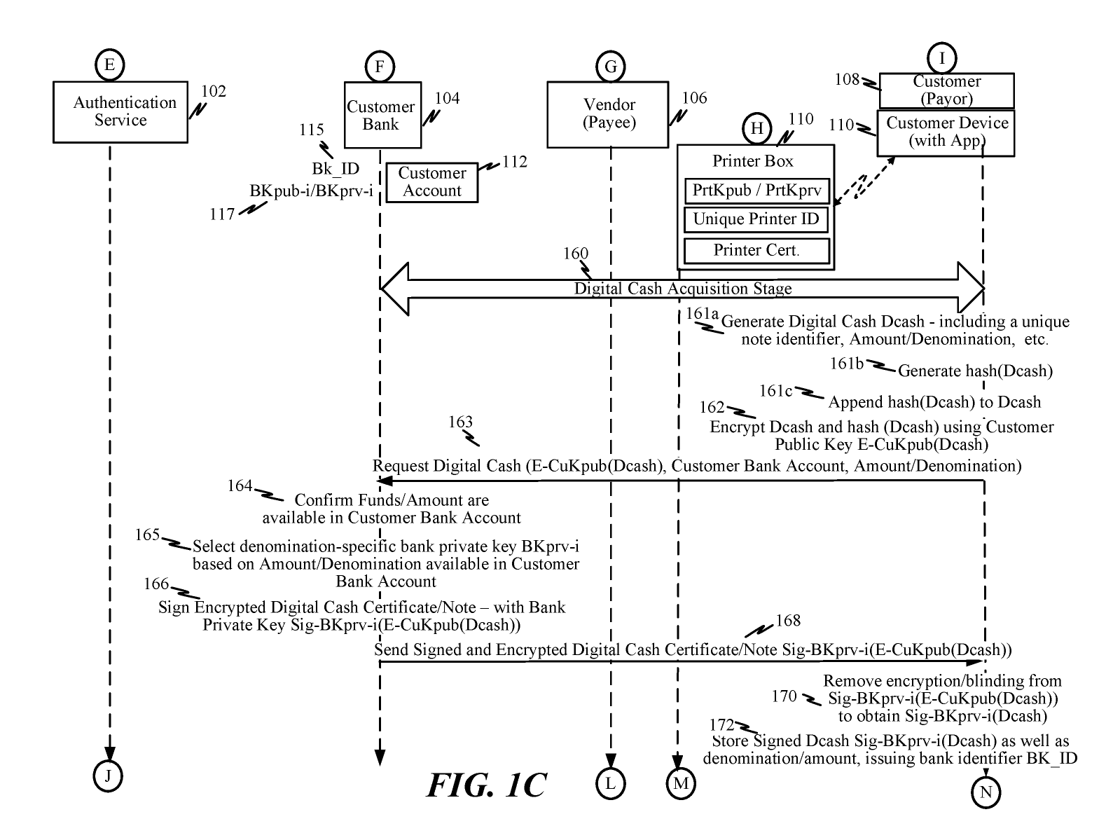

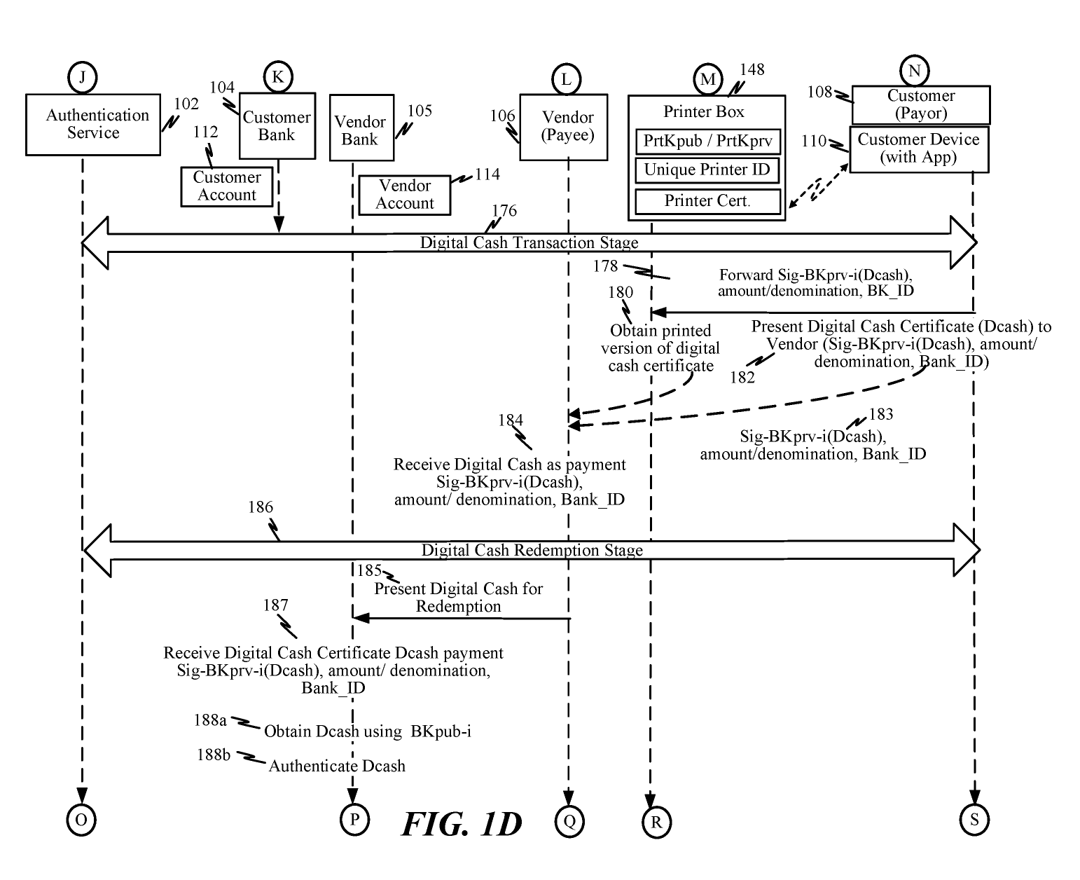

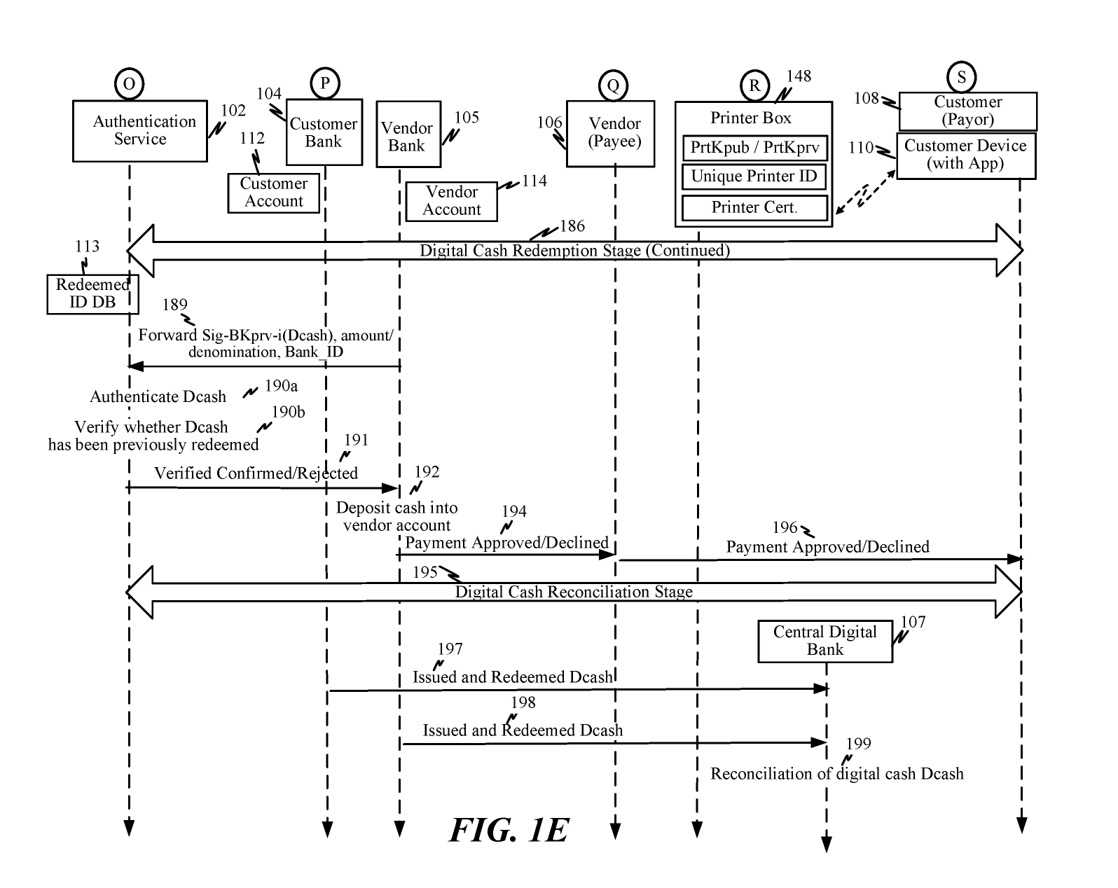

FIG. 1 (comprising FIGS. 1A, 1B, 1C, 1D, and 1E) illustrates a first example of a system for using digital cash for cash-like transactions while maintaining anonymity. This system comprises an authentication service 102, one or more banks or financial institutions (e.g., payor/customer bank 104 and payee/vendor bank 105), a vendor 106 (e.g., a payee in a transaction), and a customer 108 (e.g., payor in the transaction) or customer device 110 (e.g., mobile phone, smartphone, tablet, or computing device). All communications in FIG. 1 are assumed to be private and authenticated using standard Internet mechanisms such as transport layer security (TLS).

At some point, the customer will have setup a customer account 112 (e.g., a stored value account, savings account, checking account, credit account, etc.) with a payor/customer bank 104. The payor/customer bank 104 may have one or more associated cryptographic public/private key pairs (BKpub-i and BKprv-i) 117, which may be denomination-specific, and may serve to sign and/or encrypt digital cash certificates. That is, each public/private key pair (BKpub-i and BKprv-i) 117 may correspond to a different amount/denomination and/or currency. The payor/customer bank 104 may also have an associated unique bank identifier BK_ID 115 that may serve to identify a bank or financial institution that issues a digital cash certificate.

Likewise, the vendor 106 will have setup a vendor account 114 with a vendor/payee bank 105. Note that in various implementations, the customer account 112 and the vendor account 114 may be at different banks or financial institutions (e.g., a payor/customer bank 104, and a payee/vendor bank 105).

The customer device 110 may have loaded or installed an application for securely obtaining, generating and/or distributing digital cash. The customer device 110 may also define, obtain, and/or generate a customer public key CuKpub and private CuKpry key pair 118. Likewise, the vendor 106 (or a device used or associated with the vendor) may obtain or generate an associated vendor public key VKpub and private VKpry key pair 136.

During a customer registration stage 124, the customer device 110 may send a registration request 126 to the authentication service 102, including customer information, customer bank account, and customer public key CuKpub. The authentication service 102 obtains or generates a customer certificate 128 (e.g., as a function of customer-specific information) and sends a confirmation message 130, including the customer certificate. The customer device 110 stores 132 the customer certificate.

Similarly, during a vendor registration stage 134, the vendor 106 may send a registration request 138 to the authentication service 102, including vendor information, vendor bank account, and vendor public key VKpub. The authentication service 102 obtains or generates a vendor certificate 140 (e.g., as a function of vendor-specific information) and sends a confirmation message 142, including the vendor certificate. The vendor device 106 stores 144 the vendor certificate.

According to an optional feature, a printer box/device 148 may be used as part of the system to deploy or print digital cash. The printer box/device 148 may include a public key/private key pair (PrtKpub/PrtKprv), a unique printer identifier, and/or a printer certificate. In one example, the printer certificate may include the printer public key PrtKpub, which may be specific to each printer box/device and may be pre-provisioned.

At a printer setup stage 150, the customer device 110 may establish a communication link 152 with the printer box 148. The customer device 110 then sends a customer setup request 154 to the printer box 148. In reply, the customer device 110 (or software application therein) receives the printer identifier (Printer ID) and/or the printer public key PrtKpub 156. The customer device 110 may then store printer ID and printer public key PrtKpub 158 for subsequent use.

For purposes of illustrating how digital cash may be used while maintaining payor anonymity, the following cryptographic scheme may be used to generate, distribute, and transact in digital cash. For purposes of illustration, a message “M” is generated by a customer (where “M” may a digital cash certificate Dcash). Because the message “M” is to be kept confidential from the financial institution that will issue the digital cash certificate or note, the customer may obscure or blind “M” by using a value “r”. Consequently, a customer may generate a blinded digital cash “rM”. The blinded digital cash “rM” is sent to an issuing financial institution to request a digital cash certificate or note.

The issuing financial institution (e.g., customer bank) may have a public key “e” and a corresponding private/secret key “d” used to cryptographically secure digital cash certificates or notes. After corroborating that the requester/customer has the requested funds available (specified in the Dcash request), the issuing financial institution may cryptographically sign the blinded digital cash using a denomination/amount-specific private key “d” (e.g., BKprv-i) to generate the digitally signed blinded Dcash certificate or note (rM)^{d} which is then returned to the customer.

The customer may then obtain the signed message “M^{d}” Dcash certificate by stripping the blinding since it knows “r” and the financial institution denomination-specific public key “e” (or BKpub-i). This may be done as follows:

(rM)^{d}=r^{d}M^{d} [symbol] (strip blinding)(r^{d}r^{e})M^{d}=M^{d}.

The customer may then store M^{d} and subsequently provide M^{d} as payment to a vendor as part of a transaction. In some implementations, each digital cash Dcash within a message “M” may be a single “bill” of a standard amount/denomination. In some examples, message “M” may comprise a unique note identifier, a denomination/amount for the digital cash bill requested, an issuing bank identifier, and a hash of the unique note identifier, denomination/amount, and the issuing bank identifier.

The vendor may present M^{d} to its own bank, which can then authenticate it or have another authentication entity authenticate M^{d} by using the financial institution public key “e”, such that (M^{d})^{e}=M. The message “M” itself may be verified or authenticated based on generating a hash of the unique note identifier, denomination/amount, and the issuing bank identifier and comparing it to the hash accompanying message “M”.

One exemplary implementation of the cryptographic scheme described above is illustrated in FIGS. 1C, 1D, and 1E. This exemplary steps may be specific to the way Chaum's Digicash blind signatures work, but other known forms of blind signatures (e.g., Brand's scheme) are also covered and applicable to this process.

At a digital cash acquisition stage 160, the customer device 110 may generate digital cash certificate/note (Dcash) 161a having an associated unique note identifier for identifying the Dcash, an amount or denomination, issuing bank identifier (BK_ID), etc. The customer device 100 may then generate a hash over the digital cash (Dcash) 161b and appends it to Dcash 161c, such that Dcash=Dcash, hash (Dcash). In various examples, the digital cash certificate/note (Dcash) may be defined as a function of one or more parameters, such as:

Dcash=function (unique note identifier hash (unique note identifier)), or

Dcash=function (unique note identifier, issuing bank identifier, hash (unique note identifier, issuing bank identifier)), or

Dcash=function (unique note identifier, denomination/amount, and/or date/time, hash (unique note identifier, denomination/amount, and/or date/time)).

Dcash=function (unique note identifier, denomination, amount, and/or date/time, issuing bank identifier, hash (unique note identifier, denomination, amount, and/or date/time)).

Optionally, the digital cash certificate/note (Dcash) may also define or specify a currency. In some examples, the unique note identifier may be a function of a random or pseudo-random information, customer-secret information (e.g., generated cryptographically or in a way that prevents identification of the customer), date, time, amount, and/or denomination, etc. The “hash” function may be any function that can be used to map data of arbitrary size to data of fixed size. A cryptographic hash function allows one to easily verify that some input data maps/corresponds to a given hash value, but if the input data is unknown, it is deliberately difficult to reconstruct it (or equivalent alternatives) by knowing the stored hash value. This is used for assuring integrity of transmitted data and providing message authentication.

The digital cash certificate/note (Dcash) may then be encrypted (e.g., blinded or obscured), by the customer device 110, using the customer public key CuKpub (e.g., equivalent of “r”) to obtain an encrypted digital cash certificate/note (E-CuKpub(Dcash)) 162. Because the encrypted digital cash certificate/note (E-CuKpub(Dcash)) is encrypted using the customer public key CuKpub, only the customer device 110 is able to decrypt it since it is the only one that has the corresponding customer private key CuKprv. In some implementations, for the sake of security, the customer device 110 may dynamically generate different blinding keys for each digital cash Dcash transaction or request.

The customer device 110 may then send a digital cash request 163 to the payor bank 104, the request including, for example, the encrypted digital cash certificate/note (E-CuKpub(Dcash)), the customer bank account number, and/or the amount or denomination of the digital cash certificate).

Upon receipt of the digital cash request 163, the payor bank 104 verifies/confirms 164 that the requested amount of money is available in customer account 112 (e.g., a bank account, a line of credit, a credit card on record, etc.) and debits the customer account. A denomination-specific private key BKprv-i is then selected based on the amount/denomination specified on the request 165. Similarly, if a “currency” is specified, a currency-and-denomination-specific private key may be selected. Implicit in this process is that a single “bill” or digital cash certificate/note will be sent per request, so a single denomination-specific private key BKprv-i (i.e., corresponding to the value of the “bill”) is used. The encrypted digital cash certificate E-CuKPub(Dcash) is then digitally signed 166 using the payor bank denomination-specific private key BKprv-i so that a receiving party/entity can be certain that the digital cash certificate Dcash was approved/verified by the payor bank 104 (i.e., which can be confirmed by using the payor bank's denomination-specific public key BKpub-i). Upon signing the encrypted digital cash certificate E-CuKpub(Dcash), the payor bank 104 may withdraw the requested funds/amount from the customer account 112, just as if a cash withdrawal had been made. The cryptographically signed and encrypted digital cash certificate Sig-BKprv-i(E-CuKpub(Dcash) may then be sent 168 to the customer device 110.

As previously noted, denomination-specific keys may be used by the issuing bank to sign a digital cash certificate/note (Dcash). For instance, for $20 dollar denominations, a first denomination-specific private key BKprv20 may be used to sign the encrypted digital cash certificate/note Dcash. Meanwhile, for $100 dollar denominations, a second denomination-specific private key BKprv100 may be used to sign the encrypted digital cash certificate/note Dcash.

Where currency is also specified, currently-and-denomination-specific keys may be used, such as a first private key BKprvYEN-100, a second private key BKprvDOLLAR-100, a third private key BKprvEURO-100, etc., each have a corresponding public key.

According to some aspects, the customer may wish to request a plurality N of Dcash notes/certificates of a particular denomination (e.g., $20 dollar bills, $100 dollar bills, etc.). In such case, each individual encrypted digital cash certificate/note of the desired denomination may be individually signed with the denomination-specific private key.

According to yet other aspects, a mix of different denominations may be specified by a customer. In such case, each individual encrypted digital cash certificate/note of different denominations may be individually signed with a denomination-specific private key BKprv-i corresponding to the value of the individual digital cash certificate/note.

Note that only the customer device 110 is able to decrypt the encrypted digital cash certificate/note E-CuKpub(Dcash) since it is the only party that knows the customer private key CuKprv. Consequently, in one example, if the digital cash certificate/note Dcash is never redeemed then the cash is lost. Similarly, if the customer device 110 loses its copy of the digital cash certificate/note Dcash, or loses its secret key (e.g., customer private key CuKprv) and can no longer decrypt it, the value of the digital cash certificate/note is lost. Additionally, if the customer bank 104 was to sign the encrypted digital cash certificate/note Dcash with a denomination-specific private key that does not match the purported or advertised denomination of the digital cash certificate/note Dcash, then the signed and encrypted digital cash certificate/note Sig-BKprv(E-CuKpub(Dcash)) could not be authenticated with the corresponding denomination-specific public key (BKpub-i).

Upon receiving the signed and encrypted digital cash certificate/note Sig-BKprv-i(E-CuKpub(Dcash)), the customer device 110 may remove blinding/obfuscation by using the customer device public key CuKpub to reverse the encryption operation and obtain BKprv-i(Dcash) (which is equivalent to M^{d} described above) 170.

To verify the signed and encrypted digital cash certificate/note Sig-BKprv-i(Dcash), the customer device 110 may use the customer bank denomination-specific public key BKpub-i to authenticate the received Dcash (which is equivalent to M described above). The customer device 110 may store 172 the signed digital cash certificate/note Sig-BKprv-i(Dcash), which is equivalent to M^{d}, and/or the denomination/amount and issuing bank identifier BK_ID for subsequent/later use. Note that the customer device may obtain the issuing bank identifier BK_ID from the customer bank upon establishing the customer account 112.

At a digital cash transaction stage 176, the customer device 110 may present the signed digital cash certificate/note Sig-BKprv(Dcash), amount/denomination, and issuing bank identifier BK-ID to the vendor 106. In one example, the customer device 110 may display (or otherwise present) a version of the digital cash certificate, e.g., amount/denomination, and issuing bank identifier BK_ID to the vendor 106.

In another example, the customer device 110 may send the signed and encrypted digital cash certificate E-PrtKpub(Sig-BKprv(Dcash), amount/denomination, and/or issuing bank identifier BK_ID), to the printer 148, which decrypts the digital cash certificate using its printer private key PrtKprv, and prints a note representative of the signed digital cash Dcash certificate Sig-BKprv(Dcash) and/or amount/denomination, and/or issuing bank identifier BK_ID. For instance, the printer box 148 may print (e.g., on a physical medium such as paper) or display (e.g., on a device screen) a linear or matrix barcode representative of the signed Dcash certificate Sig-BKprv(Dcash), plus the amount/denomination, and/or issuing bank identifier BK_ID may be encoded into the barcode.

The vendor 106 may then receive/accept 184 the signed Dcash certificate Sig-BKprv(E-CuKpub(Dcash)), amount/denomination, and/or issuing bank identifier BK_ID as payment.

In a digital cash redemption stage 186, the vendor 106 may present 185 the signed digital cash certificate Sig-BKprv(Dcash), amount/denomination, and issuing bank identifier BK_ID to the vendor's bank 105 for redemption. Upon receipt 187 of the signed digital cash certificate Sig-BKprv(Dcash), amount/denomination, and issuing bank identifier BK_ID, the vendor's bank 105 may use customer bank denomination-specific public key BKpub-i, which may be previously obtained, to (optionally) obtain the digital cash Dcash (equivalent to “M” above). That is, by knowing the denomination/amount and the issuing bank identifier, the vendor bank 105 can select/obtain 188a the appropriate issuing bank denomination-specific public key BKpub-i, which can then be applied to Sig-BKprv(Dcash) to obtain Dcash. The vendor bank 105 may also authenticate 188b the digital cash Dcash by using the information therein (e.g., unique note identifier, denomination/amount, date/time, issuing bank identifier, etc.) to generate a hash value which is then compared to the hash value appended to Dcash. If these two hash values match, then Dcash is authenticated. Otherwise, the transaction may be declined.

Upon successfully authenticating Dcash, the vendor's bank 105 may forward the unique note identifier to the authentication service 102 for verification 189. The authentication service 102 may also perform authentication of the Dcash. By knowing the denomination/amount and the issuing bank identifier, the authentication service 102 can select/obtain the appropriate issuing bank denomination-specific public key BKpub-i, which can then be applied to Sig-BKprv(Dcash) to obtain Dcash. The authentication service 102 may authenticate 190a the digital cash Dcash by using the information therein (e.g., unique note identifier, denomination/amount, date/time, issuing bank identifier, etc.) to generate a hash value which is then compared to the hash value appended to Dcash. If these two hash values match, then Dcash is authenticated.

The authentication service 102 may then verify whether the Dcash has been previously redeemed by comparing the unique note identifier to its database of stored unique note identifiers of digital cash certificates. The authentication service 102 may maintain a database of redeemed identifiers 113 which is populated when a unique note identifier is initially redeemed. Upon obtaining the unique note identifier (from Dcash), the authentication service 102 checks/verifies whether the unique note identifier is already stored in the authentication service 102. If not, then the unique note identifier is stored in the database 113 and verification is confirmed (i.e., successful redemption). Otherwise, if the received unique note identifier matches an entry in the database 113, then verification is rejected (i.e., redemption failed).

Depending on whether the unique note identifier was previously redeemed or not, the redemption is confirmed or rejected 191 and the vendor's bank 105 is notified. If verification by the authentication service 102 is successful and the vendor bank 105, then the amount indicated by the digital cash certificate Dcash is deposited 192 into the vendor's account 114.

The vendor bank 105 may then send a payment approved or declined message 194 to the vendor 106 which in turn may inform the customer 108 if the payment has been approved or declined 196.

In various implementations, the database 113 that tracks digital cash certificates and redemptions may be private to the authentication service 102, or it may be publicly maintained in a block-chain like with Bitcoin.

Note that while the digital cash certificate Dcash may be printed multiple times, it can only be redeemed once since the authentication service 102 can identify whether it has been previously redeemed based on the unique note identifier.

According to one aspect, the customer 108 may obtain digital cash certificates from the customer bank 104 in any amount (e.g., $100, $200, $300, etc.). When payment from the customer 108 to the vendor 106 is an amount less than the digital cash certificate Dcash amount presented by the customer 108, then after confirmation of payment by the vendor bank 105 to the vendor 106, the vendor 106 may issue a new digital cash certificate Dcash as change for the change/difference due to the customer 108, just as with any cash payment. The change digital cash certificate Dcash issued by the vendor 106 and vendor bank 105 may be generated in a similar manner as when the customer 108 and customer bank 104 generated its digital cash certificate Dcash.

Because of the use of blind signatures (i.e., by the issuing bank), neither the authentication service 102 nor any other third party can associate the digital cash certificate Dcash issued to the customer 108 with the digital cash certificate deposited by the vendor 106. That is, the unique note identifier associated with each digital cash certificate may not include information that identifies the customer.

In the case that customer is unable to use the digital cash certificate or is concerned about the digital cash certificate being compromised, the customer device 110 can simply request the authentication service 102 to re-deposit the cash in the customer's bank account. This may un-blind the signature, but does not reveal anything other than the fact that the customer tried to use or print cash and failed/desisted.

The “withdrawal” communications are only with the customer 108, and the “deposit” communications are only with the vendor 106. This preserves anonymity of the parties from each other, and anonymity of the transaction from the Authentication Service and Bank.

Messages transmitted within the system illustrated in FIG. 1 may be encrypted with an intended recipient's public key, and authenticated (e.g., verified or decrypted) with the intended sender's private key so that the recipient can use the sender's public key to verify authenticity. As is well known in the industry, encryption and signing operations might use different but associated keys, but they are described herein as if it is a single key pair for both operations. Standardized security mechanisms, such as TLS (RFC 5246—The Transport Layer Security (TLS) Protocol . . . —IETF Tools), may be used to secure these transmissions.

According to one aspect, the customer need not use a specialized printer box to print the digital cash certificate. For instance, a representation of the digital cash certificate may be printed from the user device to any printer. But the customer risks having the digital cash certificate intercepted over the insecure link from the customer device to the insecure printer.

Similarly, the vendor 106 may use any scanner to capture the digital cash certificate from the customer device screen. But this too exposes the digital cash certificate to being intercepted and potentially misused.

In some implementations, a single bank may serve to issue digital cash Dcash. However, where multiple banks issue digital cash, a digital cash reconciliation stage 195 may serve to reconcile digital cash Dcash issued and redeemed by each bank. In one example, a central digital bank 107 may serve to track and reconcile digital cash accounts for the customer bank 104 and the vendor bank 105. Each time digital cash Dcash is issued or generated, the issuing bank owes money to the central digital bank 107, and each time digital cash Dcash is redeemed by a bank, the central digital bank 107 owes money to the redeeming bank. Thus, the customer bank 104 regularly reports issued/generated and/or redeemed digital cash 197 to the central digital bank 107. Similarly, the vendor bank 105 also regularly reports issued/generated and/or redeemed digital cash 198 to the central digital bank 107. The central digital bank 107 may then reconcile digital cash for each bank. Banks already use such mechanisms to reconcile check transactions, so this could be expanded for digital cash.

It is contemplated that the various steps, stages, and/or operations described herein may be combined, rearranged, and/or modified without departing from the novel aspects described.

### Exemplary Digital Cash Denominations

According to one aspect, the bank 104 may have a hierarchy of different signing keys. The highest level key will be used to sign certificates for subordinate keys, in much the same way that a Certificate Authority creates certificates for other entities. In this case, though, the subordinate keys may each specify or is associated with a particular cash denomination. For instance, there may be different keys for, say, $100 bills and 5 bills or denominations. When the customer requests a digital cash certificate/note for $100, the bank will use the appropriate denomination-specific key to sign the blinded data. The printed or displayed digital cash certificate/note will specify that the amount is intended to be $100. When the vendor wants to deposit the digital cash certificate/note, the bank attempts to verify the blinded signature using the key associated with $100 notes. This verification will fail unless the digital cash certificate/note really was generated using the correct associated key, even if some adversary had manipulated the image of a $5 note (digital cash certificate) to make it look like, and present as, a $100 note (digital cash certificate).

Additionally, the customer could pay $3 with a $1 note and a $2 note. But the customer could also request that the bank actually issue a $3 note (digital cash certificate), or indeed a $3.71 note or any other denomination. If the bank does not currently have a key for the requested denomination, it can easily create one on the fly. There is a potential loss of privacy here, as unusual denominations effectively link the issuing and depositing transactions.

Another aspect provides convenience for travelers by being able to “print” digital cash/currency certificates in the denomination of a country being visited. Consequently, the request 163 may specify a particular currency.

### Exemplary Customer Device and Method Operational Therein

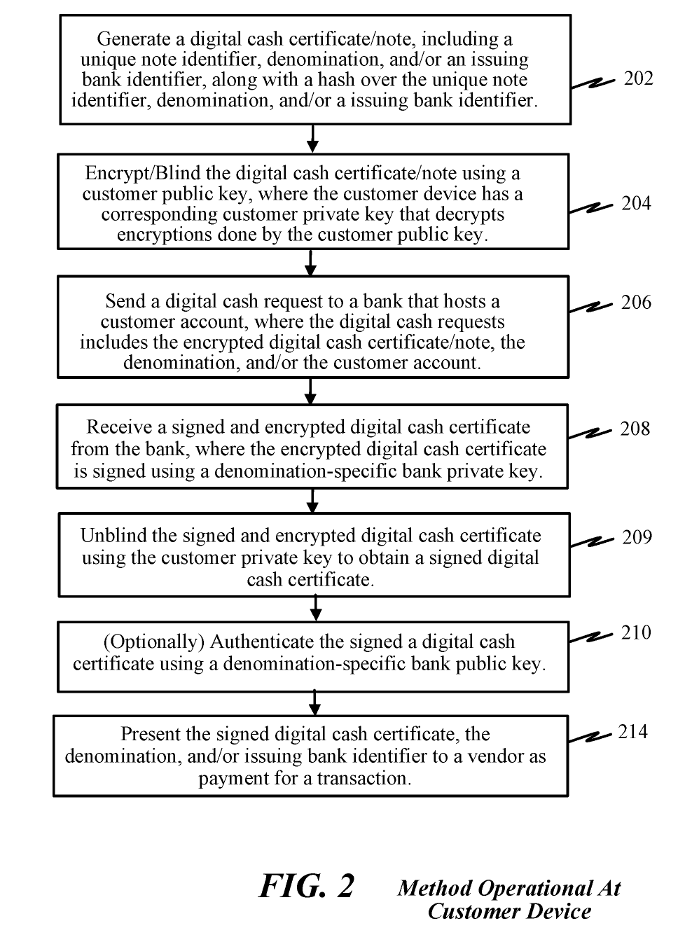

FIG. 2 illustrates a method operational in a customer device to generate and tender digital cash without associating it to the customer. The customer device may generate a digital cash certificate/note, including a unique note identifier, denomination, and/or an issuing bank identifier, along with a hash over the unique note identifier, denomination, and/or an issuing bank identifier 202. The digital cash certificate/note is then encrypted/blinded using a customer public key, where the customer device has a corresponding customer private key that decrypts encryptions done by the customer public key 204. A digital cash request is sent by the customer device to a customer bank that hosts a customer account, where the digital cash request includes the encrypted digital cash certificate/note, the denomination, and/or the customer account 206. The issuing bank identifier may correspond to the customer bank. The customer device may then receive a signed and encrypted digital cash certificate from the bank, where the encrypted digital cash certificate is signed by the bank using a denomination-specific bank private key 208. The signed and encrypted digital cash certificate may be unblinded/decrypted by using the customer private key to obtain a signed digital cash certificate 209. Optionally, the customer device may authenticate the signed digital cash certificate using a denomination-specific bank public key 210. The signed digital cash certificate, denomination, and/or the issuing bank identifier may then be presented to a vendor as payment for a transaction 214.

In one example, the digital cash certificate Dcash may include the unique note identifier (e.g., a serial number), the requested denomination, date/time, and/or other verifiable redundancy information that shows it is a valid Dcash. Note that the accompanying hash over the Dcash may be used by recipients to authenticate the digital cash certificate Dcash.

The request may be sent prior to initiation of the transaction and the amount requested may be different from the transaction amount and in standard or non-standard denominations. In situations where denomination-specific key pairs are used, when a customer requests a non-standard denomination but the bank does not have a key pair for such denomination yet, the issuing bank may create such a key pair on the fly. If the bank creates a new denomination-specific key pair, it may create a random new key pair and issues a certificate of validity for the new key pair, and publishes the new denomination-specific public key. Alternatively, the bank may use a variant of Identity Based Encryption to create the new key pair, in which case a banks master key and the denomination can be used to verify the signature without needing further certificates.

In one example, the amount requested for the digital cash certificate may be for a particular currency and for a standard currency denomination. In another example, the amount requested for the digital cash certificate may be for a particular currency and for a non-standard currency denomination.

According to another aspect, a request for a non-standard amount and/or denomination may result in a combination of multiple digital cash certificates of standard denominations being generated. For instance, if an original request is for $3.71, this can be represented as multiple digital cash certificates Dcash1-n, e.g. $2, $1, $0.50, $0.20 and $0.01, which may be requested by the customer device from the issuing bank. When the customer wishes to print or display the Dcash for $3.71, the Dcash1-n certificates may be concatenated or combined. The printed/displayed Dcash may effectively concatenate the separate digital cash certificates into a single digital cash certificate. However, in practice, these may actually be multiple separate digital cash certificates.

In one implementation, the signed and encrypted digital cash certificate (or representation thereof) may be cryptographically secured and sent to a printer device for reproduction in a tangible form.

In another implementation, the digital cash certificate (or representation thereof) may be displayed on a display device.

### Exemplary Vendor Device and Method Operational Therein

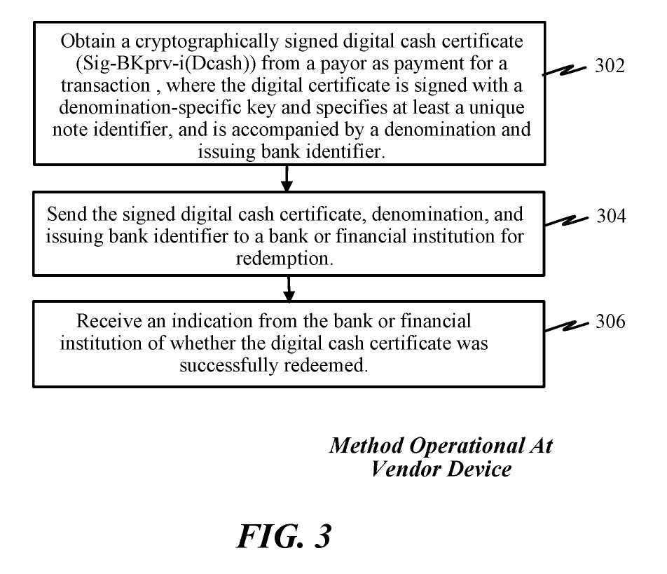

FIG. 3 illustrates a method operational in a vendor device to accept and redeem digital cash. A digital cryptographically signed digital cash certificate (Sig-BKprv-i(Dcash)) may be obtained or received from a payor as payment for a transaction, where the digital certificate is signed with a denomination-specific key and specifies at least a unique note identifier, and is accompanied by a denomination and issuing bank identifier 302. The signed digital cash certificate, denomination, and issuing bank identifier may then be sent to a vendor bank or financial institution for redemption 304. The vendor device may then receive an indication from the bank or financial institution of whether the digital cash certificate was successfully redeemed 306. Depending on the indication, the transaction may be completed or rejected.

One or more of the components, steps, features, and/or functions illustrated in the Figures may be rearranged and/or combined into a single component, step, feature or function or embodied in several components, steps, or functions. Additional elements, components, steps, and/or functions may also be added without departing from the invention. The apparatus, devices, and/or components illustrated in the Figures may be configured to perform one or more of the methods, features, or steps described in the Figures. The algorithms described herein may also be efficiently implemented in software and/or embedded in hardware.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A method for anonymizing digital cash transactions, comprising:
generating, at a customer device, a digital cash certificate as a function of a unique note identifier, amount/denomination, and/or issuing bank identifier, and a hash of the unique note identifier, amount/denomination, and/or issuing bank identifier;
encrypting/blinding the digital cash certificate using a customer public key for the customer device to obtain an encrypted digital cash certificate, wherein a corresponding customer private key is known only to the customer device;
sending a digital cash request to a bank that hosts a customer account, the digital cash request including the encrypted digital cash certificate, the amount/denomination, and a customer account with the bank;
after confirming that the customer account has the requested amount/denomination, digitally signing the encrypted digital cash certificate, using a denomination-specific bank private key known only to the bank to obtain a signed and encrypted digital cash certificate; and
sending the signed and encrypted digital cash certificate to the customer device.

2. The method of claim 1, further comprising:
decrypting/unblinding the digital cash certificate using the corresponding customer private key to obtain a signed digital cash certificate.

3. The method of claim 2, further comprising:
providing/presenting, by the customer device, the signed digital cash certificate, denomination, and issuing bank identifier to a vendor as payment for a transaction.

4. The method of claim 3, further comprising:
sending, by the vendor, the signed digital cash certificate, denomination, and issuing bank identifier to a vendor bank.

5. The method of claim 4, further comprising:
authenticating, by the vendor bank, the signed digital cash certificate by using a denomination-specific bank public key to obtain the digital cash certificate;
verifying, by the vendor bank, the payment by sending the signed digital cash certificate, denomination, and issuing bank identifier to the authentication service.

6. The method of claim 5, further comprising:
authenticating, at the authentication service, the signed digital cash certificate by using a denomination-specific bank public key to obtain the digital cash certificate and the unique note identifier therein;
determining, at the authentication service, whether the unique note identifier was previously redeemed;
sending a payment verification message to the vendor bank if the unique note identifier was not previously redeemed; and
sending a payment rejection message to the vendor bank if the unique note identifier was previously redeemed.

7. The method of claim 6, wherein the authentication service maintains a database of previously redeemed unique note identifiers.

8. The method of claim 6, further comprising:
crediting a vendor account at the vendor bank with the amount of the digital cash certificate upon receiving the payment verification message; and
providing the vendor an indication of payment upon receiving the payment verification message.

9. The method of claim 6, further comprising:
receiving, at the vendor bank, a payment rejection message from the authentication service; and
providing the vendor an indication of payment rejection upon receiving the payment rejection message.

10. The method of claim 1, further comprising:
debiting, at the bank, the requested amount from the customer account concurrent with signing the encrypted digital cash certificate.

11. The method of claim 1, wherein the digital cash certificate does not identify the customer account from where the cash was drawn or an associated customer to whom it was issued.

12. A method for operational at a customer device, comprising:
generating, at a customer device, a digital cash certificate as a function of a unique note identifier, amount/denomination, and/or issuing bank identifier, and a hash of the unique note identifier, amount/denomination, and/or issuing bank identifier;
encrypting/blinding the digital cash certificate using a customer public key for the customer device to obtain an encrypted digital cash certificate, wherein a corresponding customer private key is known only to the customer device;
sending a digital cash request to a bank that hosts a customer account, the digital cash request including the encrypted digital cash certificate, the amount/denomination, and a customer account with the bank;
receiving, from the bank, a cryptographically signed and encrypted digital cash certificate to the customer device, wherein the encrypted digital cash certificate to the customer device is signed with a denomination-specific bank private key known only to the bank;
decrypting/unblinding the digital cash certificate using the corresponding customer private key to obtain a signed digital cash certificate;
providing/presenting, by the customer device, the signed digital cash certificate to a vendor as payment for a transaction.

13. The method of claim 12, wherein the request is sent prior to initiation of the transaction and the amount requested is different from the transaction amount.

14. The method of claim 12, wherein the amount requested for the digital cash certificate is for a particular currency and for a standard currency denomination.

15. The method of claim 12, wherein the request is for an amount implicit in the denomination specified.

16. The method of claim 12, wherein presenting a representation of the signed digital cash certificate includes sending a cryptographically secured version of the digital cash certificate to a printer device for reproduction in a tangible form.

17. The method of claim 11, wherein presenting a representation of the signed digital cash certificate includes displaying the representation of the digital cash certificate on a display device.

18. A method for operational at a vendor device, comprising:
obtaining a cryptographically signed digital cash certificate from a payor as payment for a transaction, where the digital certificate is signed with a denomination-specific key and specifies at least a unique note identifier, and is accompanied by a denomination and issuing bank identifier;
sending the digital cash certificate, denomination, and issuing bank identifier to a bank or financial institution for redemption; and
receiving an indication from the bank or financial institution of whether the digital cash certificate was successfully redeemed.
